(19) United States
(12) Patent Application Publication
(10) Pub. No.: US 2006/0026014 A1
(43) Pub. Date: Feb. 2, 2006

(54) Methods, systems and computer program products for performing subsequent transactions for prior purchases

(75) Inventors: Robert G. Bolduc, Arlington, TX (US); Sanjay Joshi, Coppell, TX (US); Roger W. Kelly, Grapevine, TX (US); Ana G. Orantes, Euless, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: GetThere Inc.

(21) Appl. No.: 10/903,882

(22) Filed: Jul. 30, 2004

(51) Int. Cl. G06Q 99/00

(52) U.S. Cl. 705/1; 705/17

(57) ABSTRACT

Information about whether and how subsequent transactions can be carried out for purchases of items from a provider can be automatically processed. Data regarding whether and how the subsequent transactions can be carried out is received from the provider or a surrogate of the provider. The data is arranging into a database, and a record is created from the data in the database. The creating of the record includes retrieving, from the database, data that is at least indicative of whether or how at least one subsequent transaction can be carried out for at least one item purchased from the provider, and populating the record with the retrieved data. The populating of the record with the retrieved data includes converting at least some of the retrieved data into a higher-level computer language, which is preferably extensible markup language.

### BACKGROUND OF THE INVENTION

The present invention pertains to purchasing goods and services online and, more particularly, to performing a subsequent transaction (e.g., a cancellation or exchange) for a previously completed purchase.

Online shopping for goods and services is a widely accepted and convenient alternative to the time consuming practice of physically traveling between the locations of, or talking on the telephone with, vendors of goods and services. Accordingly, there are a variety of conventional online shopping systems. However, it is common for online shopping systems to have limited automated capabilities for facilitating cancellations and exchanges for prior purchases. For example, it is common for websites to be configured so that a user who has made an online purchase is not able to facilitate a cancellation or exchange for that prior purchase online, and if the option of an online cancellation of a prior purchase is provided, this option is typically so unsophisticated that it promotes numerous invalid cancellations. That is, it is conventional to have to speak on the telephone with the vendor or other provider to accurately cancel or make an accurate exchange for an online purchase.

As a more particular example, in order to attempt to accurately cancel or exchange a travel itinerary consisting of tickets for airline flights, it is conventional to have to call a travel agent, or the like. In these situations, it is conventional for the agent to have to search through pertinent data about the itinerary that is stored by a global distribution system (GDS), such as Sabre, and figure out whether there can be a cancellation or exchange and any associated repercussions. More specifically, it is conventional for the agent to look up the itinerary at the GDS and get from the GDS the entire “rules display” that pertains to it, and then read the rules display to determine whether there can be a cancellation or exchange, and any associated repercussions. For travel itineraries that include tickets for airline flights, the rules displays which are reviewed by travel agents and provide information about making cancellations and exchanges can be very complicated and tedious, and interpreting them can be subjective. This can result in errors that can disadvantageously increase the cost of doing business and can also have a negative impact on customer satisfaction.

Accordingly, improvements are desired with respect to making subsequent transactions (e.g., cancellations and exchanges), particularly in the context of online shopping and the travel industry.

### BRIEF SUMMARY OF SOME ASPECTS OF THE INVENTION

In accordance with one aspect of the present invention, methods, systems, and computer program products are provided for automating the process of determining whether and/or how a subsequent transaction can be completed for a previously purchased item. The previously purchased item can be anything that has been purchased (e.g., anything for which an obligation to make a payment has been incurred, even if the payment will be made subsequently). In one embodiment, the previously purchased item is a travel itinerary and the subsequent transaction is a cancellation or exchange of the travel itinerary.

In accordance with one aspect of the present invention, data is received from the provider of the purchased item or a surrogate of the provider, such as a global distribution system. The data provides information about whether and/or how subsequent transactions can be carried out for purchases from the provider. After being received, the data is arranged in at least one database, and a record is created from the data in the database. The record is created in response to a request which stems from a user expressing an interest in a subsequent transaction for the purchased item. The record can be used by software modules to determine whether and/or how a subsequent transaction can be carried out for the item purchased.

The creating of the record can include retrieving, from the database, data that is indicative of whether and/or how a subsequent transaction can be carried out for an item previously purchased from the provider, and populating the record with the retrieved data. The populating of the record with the retrieved data preferably includes converting at least some of the retrieved data, which is computer-readable data and preferably serialized alphanumeric data, into a relatively higher-level computer language, which is preferably extensible markup language. It is preferred for the data in the record to be arranged in a predetermined manner, so that the data which is most restrictive with respect to the subsequent transaction(s) is most prominent. When the item purchased is a travel itinerary, it is preferred for a “fare linear” to be associated with the travel itinerary, and for the fare linear to be used in the retrieving of the data from the database. Fare linears are discussed in greater detail below with reference to block 110 of FIG. 2 and block 205 of FIG. 3.

As alluded to above, the foregoing aspect can further include receiving a request for a subsequent transaction for a previously purchased item, with the creation of the record being responsive to the request. It can also further include querying the record to determine whether and/or how the subsequent transaction can be facilitated. In addition, information from the record can be used in calculating any monetary refund or monetary amount that will be due if the subsequent transaction is completed.

The record is preferably used in conjunction with a website and booking engine to facilitate an online exchange or cancellation of a prior purchase. As mentioned above, the previously purchased item may be a travel itinerary, and the website and the booking engine may operate in conjunction with a global distribution system, such as Sabre, to facilitate the cancellation or exchange. Likewise, the purchase of the previously purchased item may be facilitated by the website and the booking engine operating in conjunction with the global distribution system.

The foregoing and other aspects of the present invention are described in greater detail below.

### BRIEF DESCRIPTION OF THE DRAWINGS

Having thus described some aspects of the invention in general terms, reference will now be made to the accompanying drawings, which are not necessarily drawn to scale, and wherein:

FIG. 1 is a block diagram that schematically illustrates, at a high level, a commerce system that can function to enable an online purchase, and thereafter, and depending upon the terms of the prior purchase, can be used to facilitate an online transaction for the prior purchase and at the same time handle at least initial aspects of any associated refund or additional charges online, in accordance with a principle embodiment of the present invention;

FIG. 2 is a flow diagram that illustrates operations of a booking engine and website that are located on a vendor's server that is part of the commerce system of FIG. 1; and

FIG. 3 is a flow diagram that illustrates operations of a rules engine that can be located on a consultant's server that is part of the commerce system of FIG. 1.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

General Overview

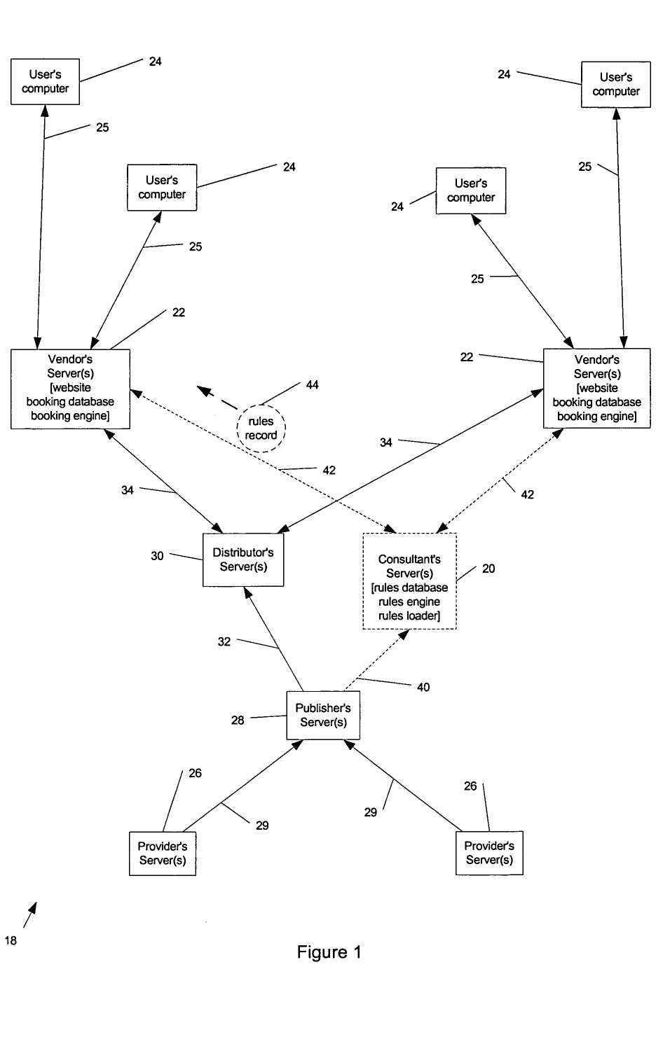

Generally described and in accordance with an aspect of a principle embodiment of the present invention, an end user can use an at least partially Internet-based commerce system 18 (FIG. 1) to purchase goods and/or services online (e.g., purchase airline tickets over the Internet) in a conventional, real-time, automated manner. Thereafter, and further in accordance with the principle embodiment of the present invention, the commerce system 18 can, depending upon the terms of the prior purchase (e.g., restrictions and penalties specified in the agreement under which the prior purchase was consummated), be used by the user to facilitate a subsequent transaction (e.g., a void/refund or exchange) for the prior purchase. In accordance with the principal embodiment of the present invention, making a payment to reserve a good or service or otherwise incurring an obligation to make a payment associated with the right to use or have access to goods or services is considered a purchase, even if the payment can be made subsequently.

Solely throughout this Detailed Description section of this disclosure:

Purchase(s)” and “prior purchase(s)” preferably refer to: automated, real-time, online purchase(s) (e.g., purchases made over the Internet) that were made using a commerce system of the type shown in FIG. 1.
The “subsequent transaction(s) for the prior purchase(s)” preferably refers to: automated, real-time, online subsequent transaction(s) for the prior purchase(s) (e.g., cancellation(s) or exchange(s) for the prior purchase(s) over the Internet) made using a commerce system of the type shown in FIG. 1, and it preferably also includes the handling, in real-time, of at least initial aspects of the associated financial repercussions.
The “initial aspects of the associated financial repercussions” preferably refers to: calculating and displaying to the user overall financial considerations associated with the subsequent transaction(s), including: identifying any penalty(s) for the subsequent transaction(s) and displaying them to the user, using any penalty(s) in the calculating and displaying to the user of any refund or amount due associated with the subsequent transaction(s), and requesting a confirmation from the user that they wish to consummate the subsequent transaction(s).

Preferably an automated consultant, or more specifically software modules and database(s) that can respectively be referred to as a rules engine, a rules loader, and a rules database, are located on a consultant's server 20. These features work together to automatically receive, store, retrieve and provide information regarding the terms of the prior purchases (e.g., restrictions and penalties specified in the agreements under which the prior purchases were consummated). As a result, the terms can be obtained in real-time, and they can be used for determining in an automated and real-time manner whether and how the subsequent transactions for the prior purchases can be carried out. In this regard, it is preferred for the end users of the commerce system 18 to respectively interface with web site(s) for consummating the prior online purchases as well as any subsequent transactions for the prior purchases, and for the automated consultant to operate in conjunction with the web site(s) in a manner that, depending upon the terms, facilitates or blocks the subsequent transactions for the prior purchases.

Overview of the Commerce System

Those of ordinary skill in the art will understand that the blocks 22, 24, 26, 28, 30 and communication paths 25, 29, 32, 34 that are illustrated by solid (i.e., not dashed) lines in FIG. 1 are generally illustrative of a conventional system that has been used for many years to enable users to complete online booking of travel services, such as seats on airline flights, hotel rooms and rental cars. Even in accordance with the principle embodiment of the present invention, the software modules that are for running on, and the databases that are for being contained on, the computers 24 and servers 26, 28, 30 can all be substantially conventional. Notwithstanding the foregoing, in FIG. 1 and in this Detailed Description section of this disclosure, even conventional features of the commerce system 18 are at times described in broad and general terms, so as not to unnecessarily limit the scope of the present invention.

In accordance with the principle embodiment of the present invention, multiple vendors are associated with the commerce system 18, and each vendor provides a website via their computer server 22. For each of the vendor's servers 22, its website, booking database and booking engine are schematically illustrated thereon in FIG. 1. The websites and associated booking engines are preferably for selling goods and services (e.g., travel services) in a conventional manner, and for at least partially facilitating the subsequent transactions for the prior purchases, as will be discussed in greater detail below. In order to make purchases (e.g., book travel services), the users of the commerce system 18 use the web browsers on their computers 24 to access, via the Internet, the web sites on the vendor's servers 22, and they shop at these websites. These communications between the user's computers 24 and the vendor's servers 22 are schematically illustrated in FIG. 1 by Internet communication paths 25, which respectively extend between the user's computers 24 and the vendor's servers 22. Communications over each Internet communication path 25 are preferably facilitated by the respective vendor's website, which is located on the respective vendor's server 22, receiving information from, and submitting information to, the respective user via the Internet and the user's web browser on their computer 24. Accordingly, and solely throughout this Detailed Description section of this disclosure, the “user(s) shopping at the vendor(s)' website(s)” preferably refers to: the user(s) using their web browser(s) on their computer(s) 24 to respectively access the vendor(s)' website(s) (e.g., on the vendor(s)' servers 22) via the Internet communication path(s) 25 and reviewing the goods and services that are being offered via the vendor(s)' website(s).

In accordance with one embodiment of the present invention, the vendors are not the ultimate providers of the items that are offered for sale via the vendors' websites. Rather, multiple different providers, such as airline companies, are the ultimate providers of the services and goods that are offered via the vendors' websites. In this regard, multiple different providers, such as airline companies, transmit information about their items that they intend to have offered for sale via the vendors' websites. The providers transmit this information from their computer servers 26 to the computer server 28 of a publisher. The publisher is a central authority which collects and distributes this information. The information being sent can be airline fare and fare-related data, which includes terms such as restrictions and penalties under which the fares can be purchased. These communications are sent over uploading communication paths 29 that respectively extend from the provider's servers 26 to the publisher's server 28. In accordance with one embodiment of the present invention, the publisher that collects and distributes the information via its server 28 is preferably the Airline Tariff Publishing Company (ATPCO).

The publisher sends information about the goods and services being offered by the providers (e.g., airline fare and fare-related data) from its server 28 to the computer server 30 of multiple different distributors which aggregate and further distribute the information, and these distributors are preferably global distribution systems (GDS). Only a server 30 associated with a single distributor is illustrated in FIG. 1, although there may be multiple distributors and their respective servers. These communications from the publisher's server 28 to the distributor's server 30 are over a publishing communication path 32. As an example, a well known provider of GDS services is Sabre.

As schematically illustrated in FIG. 1, the distributor forwards on information about the goods and services being offered by the providers (e.g., airline fare and fare-related data) from its server 30 to the servers 22 of multiple different online vendors. Typically this information is sent from the distributor's server 30 to a vendor's server 22 in response to requests for information from a booking engine on the vendor's server 22, with these requests being responsive to user(s) shopping at the vendor's website. For example, while a user is shopping on a vendor's website and requests that a search be performed for airline tickets that are available between an origin and an destination for a particular date, or the like, it is conventional for the booking engine to facilitate the search and have the search results displayed to the user via the vendor's website. More specifically, the booking engine conventionally facilitates the search by communicating with the distributor's server 30 and causing a search to be performed through database(s) on the distributor's server 30 that contain information about airline tickets that are relevant to the search. These communications between the distributor's server 30 and the vendors' servers 22 are over distributing communication paths 34 that respectively extend between the distributor's server 30 and the vendor's servers 22.

In accordance with one embodiment of the present invention, the online vendors are preferably vendors of travel services. Although only two vendor's servers 22 are illustrated in FIG. 1, there can be more or less. When there are multiple vendor's servers 22, for example as illustrated in FIG. 1, then the services provided by the consultant's server 20 are preferably services that are shared by the multiple vendors. As an example, the vendor's servers 22 illustrated in FIG. 1 can respectively be the server associated with a vendor which provides travel services for leisure travelers, and the server associated with a vendor which provides travel services for business travelers. As an example, a vendor which conventionally provides travel services for leisure travelers is Travelocity.com, and a vendor which provides travel services for business travelers is GetThere.com. Although Travelocity.com and GetThere.com are business affiliates, it is possible for a variety of nonaffiliated companies to utilize the services of the consultant and its server 20. In this regard, an application program interface can be published for enabling all interested parties to use the consultant and its server 20, so long as the interested parties make available sufficient information to the consultant and its server 20 so that it can operate as described herein.

As alluded to above, those of ordinary skill in the art will appreciate that it is conventional for the vendor's servers 22 to frequently communicate with the distributor's server 30, respectively via the distributing communication paths 34, while users are shopping at the vendors websites. That is, communications take place over the distributing communication paths 34 between the vendor' servers 22 and the distributor's servers 30 in real-time. In contrast, at least some of the uploads of information over the uploading communication paths 29 and the publishing communication path 32 are intermittent and generally independent of the communications over the distributing communication paths 34. Nonetheless, the uploads of information over the uploading communication paths 29 and the publishing communication path 32, in conjunction with the operativeness of the websites and booking engines on the vendor's servers 22, advantageously allows each of the websites to simultaneously offer for sale the goods and services from multiple providers. More specifically, software modules on the distributor's server 30 function to aggregate the information uploaded to it from the publisher's server 28 via the publishing communication path 32, so that the booking engines on the vendor's servers 22 can use the aggregated data. Accordingly, the distributor (e.g., the GDS) can be characterized as an aggregator of data from the providers. Similarly, the publisher (e.g., ATPCO) can be characterized as a surrogate of the providers.

When a user shopping at a vendor's website selects to purchase one of the goods or services offered by the website, it is conventional for there to be communication between the vendor's server 22 and the distributor's server 30 via the distributing communication path 34, such as to confirm that the goods or services being offered are still available. If the item that is the subject of the sale is still available and the user chooses to purchase it, the purchase is initially facilitated by the vendor's server 22, and further completed by the distributor's server 30. This facilitating by the website and booking engine on the vendor's server includes: 1) receiving payment, or a commitment to may, from the user and distributing the payment accordingly so that at least some of it eventually reaches the respective provider, and 2) there being a communication between the vendor's server 22 and the distributor's server 30 via the distributing communication path 34 to document the purchase. The distribution of the payment can be facilitated via an intermediary, such as a creditor (e.g., the purchase may be made using a credit card) and/or another agency (e.g., the Airlines Reporting Corporation) which facilitates transfers of funds.

The vendor's servers 22 can include at least some conventional software modules and databases, such as for providing the basic webpages for facilitating some of the users' shopping at the vendors' websites. However and in accordance with the principal embodiment of the present invention, new features have been added to the conventional features of the commerce system 18, and these new features include: (1) the consultant service along with its associated server 20 and publishing and consultation communication paths 40, 42 that are illustrated by dashed (i.e., not solid) lines in FIG. 1; and (2) new and/or modified software modules that have been associated with the vendor's servers 22 for interfacing with the consultant's server 20 and enhancing the interfacing with the user's computers 24 (e.g., enhancing the operativeness of the booking engines and websites on the vendor's servers 22). Generally described and in accordance with one embodiment of the present invention, software modules and database(s) that can respectively be referred to as a rules engine, rules loader and rules database are located on or in communication with the consultant's server 20. These operate in conjunction with at least software modules on the vendor's servers 22 to enable, if appropriate, the users to use their web browsers on their computers 24 to access, via the Internet communication paths 25, web pages that are provided by the vendor's servers 22. These web pages at least partially facilitate the subsequent transactions for the prior purchases, as will be discussed in greater detail below.

At least historical rules data, which is discussed in greater detail below, is uploaded from the publisher's server 28 to the consultant's server 20 along the publishing communication path 40. The publishing communication path 40 can be at least generally like the conventional publishing communication path 32. The consultation communication paths 42 respectively extend between the consultant's server 20 and the vendor's servers 22. Packages of information are respectively passed between the consultant's server 20 and the vendor's servers 22 along the consultation communication paths 42 using TCP/IP and XML/HTTP protocols, as will be discussed in greater detail below.

The communications via the communication paths 25, 29, 32, 34, 40, 42 can be facilitated by way of any protocols/types of communication (e.g., wired or wireless) that are suitable for supporting the functionality of the present invention. Similarly, the communication paths 25, 29, 32, 34, 40, 42 can be any type of paths/connections (e.g., wired or wireless) that are suitable for supporting the functionality of the present invention. For example, each of the Internet communication paths 25 can be replaced with other types of communication/communication paths respectively between the vendor's servers 22 and the user's computers 24. That is, the communication paths 25 could be over networks other than the Internet, and use the respective protocols of those other networks. Thus, the websites that are discussed herein as respectively operating on the vendor's servers 22, as well as the web browser on the user's computers 24, could be replaced with other types of suitable software programs.

Although the principle embodiment of the present invention is primarily described in the context of features, operations and communications being respectively segregated between the various computers 24, servers 20, 22, 26, 28, 30 and communication paths 25, 29, 32, 34, 40, 42, it is also within the scope of the present invention for there to be less or more segregation in this regard. As one example, the consultant's server 20 can be omitted, and the features on it could be moved to one or each of the vendor's servers 22, or moved to any of the other servers 26, 28, 30.

Software Modules and Databases of the Consultant's Server

The consultant's server 20 includes some conventional software modules for facilitating its basic and conventional operations. In accordance with the principle embodiment of the present invention, the consultant's server 20 further includes the historical rules database, rules loader software module(s) for loading the rules database, and fare rules engine (e.g., a collection of software modules) for receiving, processing and responding to requests for information from the booking engine on the vendor's servers 22, as will be discussed in greater detail below. The rules database, rules engine and rules loader are schematically illustrated in FIG. 1 as being on the consultant's server 20.

Because the consultant's server 20 may experience a lot of traffic (i.e., may receive many requests for information from the booking engine), and because redundancy may be beneficial in the case of any partial malfunctions which might occur, the consultant's server 20 can include redundant features (e.g., multiple substantially similar rules loaders, multiple substantially similar rules databases, and multiple substantially similar rules engines) and a load balancer for distributing the traffic between the redundant features. Likewise, there may be multiple consultant's servers 20 between which the load is balanced. Nonetheless, and for the purpose of clarifying the description, in the following only one of each of the rules database, the rules loader, and the rules engine will be referenced for ease of understanding.

Populating the Rules Database

In order for the commerce system 18 to be used, in accordance with one embodiment of the present invention, to respectively facilitate and prevent the subsequent transactions for the prior purchase, the rules database of the consultant's server 20 is first populated with historical rules data. This historical rules data includes information that can be used for determining prior purchases' terms (e.g., restrictions and penalties specified in the agreements under which the purchases respectively were consummated). In addition, the historical rules data in the rules database is preferably periodically updated so that it remains current with the ongoing purchases that continually take place. This periodic updating can be six times a day or more or less.

In accordance with one embodiment of the present invention, all of the historical rules data is preferably supplied in packages from the publisher's server 28 to the transactions consultant's server 20 via the publishing communication path 40. A relatively large package of historical rules data may be necessary to initially prepare the rules database for use, and it can be sent in one large transmission. For example, it is preferred for the rules database to include at least the most recent past thirteen months of fares and fare rules information. The subsequent and periodic updating packages of historical rules data for the rules database, which can be referred to as “incrementals” and are updates to the initial large transmission, can be identical to the conventional packages of data that are periodically sent from the publisher's server 28 to the distributor's server 30 via the publishing communication path 32. These conventional packages of data should be suitable because they include, among other things, the terms (e.g., restrictions and penalties) for the purchases that are facilitated by way of the users shopping at the vendors' websites. Alternatively, the packages of historical rules data that are supplied from the publisher's server 28 to the transactions consultant's server 20 can include a subset of the data included in the conventional packages of data that are sent from the publisher's server 28 to the distributor's server 30 via the publishing communication path 32, so long as the subset contains sufficient information about the terms of the prior purchases to enable the vendor's servers 22 and consultant's server 20 to cooperate in the manner described herein to respectively block and facilitate the subsequent transactions for the prior purchases.

Software Modules and Databases of a Representative Vendor's Server

Some Conventional Features of the Representative Vendor's Server

A representative vendor's server 22 conventionally includes a booking engine (e.g., software modules) and website that operate together and with the distributor's server 30 so that the users can shop at the website to make purchases. The vendor's server 22 also includes a booking database for storing some information about the purchases. The websites, booking databases and booking engines are schematically illustrated in FIG. 1 on the respective vendor's servers 22. Features of the booking engine operate in a conventional manner to initiate and at least partially control the communications over the respective distributing communication path 34 in a conventional manner.

Overview of Some Additional Features of the Representative Vendor's Server in Accordance with One Embodiment of the Present Invention

In accordance with one embodiment of the present invention, the above-described conventional features of the vendors' server 22 are maintained and enhanced. For example, for a representative vendor's server 22, its booking engine is further operative for initiating and at least partially controlling the communications over the respective consultation communication path 42, and for operating in conjunction with the website of the vendor's server 22 to respectively block and facilitate subsequent transactions for the prior purchases, as will be discussed in greater detail below. Also, pages on the website operating on the representative vendor's server 22 have preferably been enhanced and/or added so that there are web pages including buttons and/or data-entry points, or the like, that can be manipulated by the users, via the web browsers on their computers 24, to respectively initiate some of the operations of the present invention.

Operations of a Representative Vendor's Booking Engine/Website with Respect to a Subsequent Transaction for a Prior Purchase

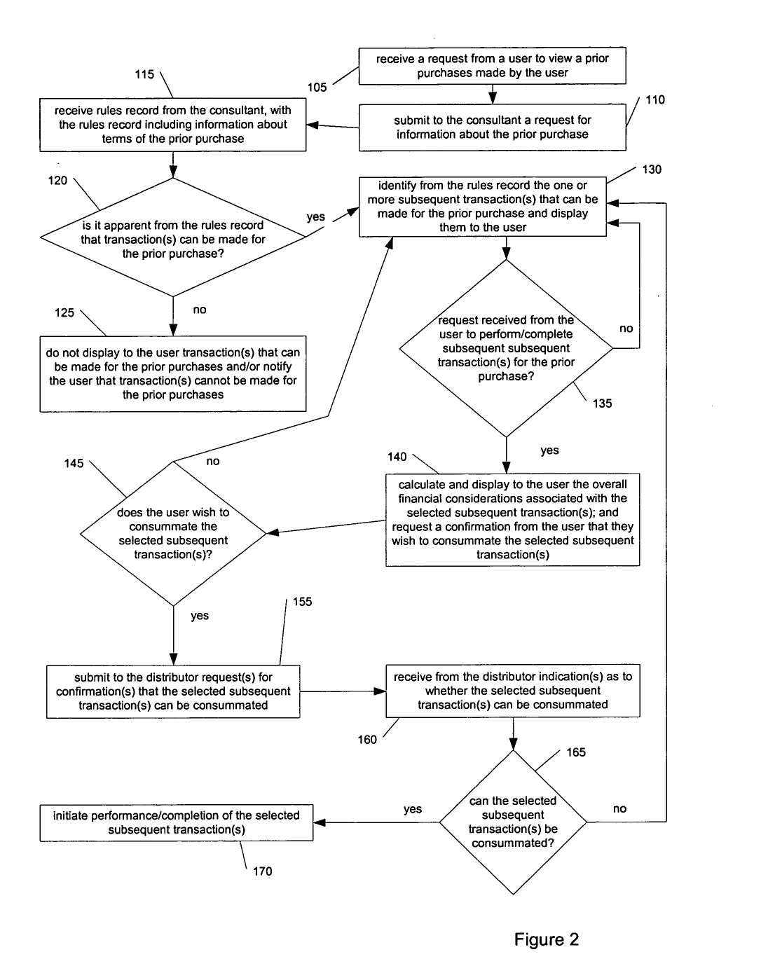

FIG. 2 primarily illustrates operations of the booking engine and website on a representative one of the vendor's server 22, with the illustrated operations being in response to a user prompting for a subsequent transaction for a prior purchase by the user. The user does this prompting by using the web browser on their computer 24 to interact with the website via the Internet communication path 25. That is, the operations illustrated by FIG. 2 take place after the user made the prior purchase using the booking engine/website on the vendor's server 22 in a conventional manner, so that the booking database preferably has a record of the prior purchase and this record is readily available to the booking engine/website. Alternatively, the prior purchase could have been made by means other than the booking engine/website on the vendor's server 22; nonetheless, in such a case it is preferred for the record of the prior purchase to have been uploaded to the booking database on the vendor's server 22 or for the booking engine/website on the vendor's server 22 to otherwise have ready access to the record of the prior purchase, such as from the distributor's server 30. Also, it is preferred for the goods or services that are the subject of the prior purchase to have not yet been delivered or otherwise provided to the user at the time of the operations illustrated by FIG. 2. It is preferred for the users to use the website for all of their subsequent transactions, such that the operations of FIG. 2 will be repeated many times, and so that it may be the case that multiple occurrences of the operations of FIG. 2 occur simultaneously.

In the following, the operations illustrated by FIG. 2 are described with respect to a representative vendor's server 22 and a representative user's computer 24, in accordance with the principle embodiment of the present invention. At block 105, the website receives a request from the user, via the Internet communication path 25, to view or otherwise access one or more of the user's prior purchases. The prior purchase may be an upcoming ticketed itinerary, which includes one or more segments of a trip that has not yet been taken. For example, a first segment of the trip can be defined by a ticket for a seat on an outbound airline flight, a second segment of the trip can be defined by a reservation for a hotel room, and a third segment of the trip can be defined by a ticket for a seat on an inbound airline flight. Nonetheless, other types of purchases, of either goods or services, are also within the scope of the present invention.

At block 110, the booking engine submits to the rules engine, which is preferably on or in communication with the consultant's server 20, a request for information about the prior purchase. This request of block 110 is submitted over the consultation communication path 42. The information that the booking engine “desires” to receive in response to the request of block 110 is information about the terms of the prior purchase (e.g., restrictions and penalties specified in the agreement under which the prior purchase was consummated) that will be sufficient to enable the website/booking engine to appropriately facilitate or block subsequent transaction(s) for the prior purchase, as will be discussed in greater detail below. Accordingly, the request for information that is submitted at block 110 includes sufficient information to enable the rules engine to obtain the desired information from the rules database.

In accordance with one embodiment of the present invention, the prior purchase is a travel itinerary, and it is preferred for the information submitted at block 110 to include the “fare linear” from the electronic ticket record that is part of the passenger name record that is assigned to the itinerary. An electronic ticket record and passenger name record are created in a conventional manner each time an individual books a seat on a commercial aircraft, books a hotel room, or rents a car, and a fare linear is a code that is conventionally included in electronic tickets and passenger name records. It is conventional for all electronic tickets and passenger name records to include a fare linear; therefore, and as an alternative, the fare linears can be obtained from the passenger name records. A fare linear includes sufficient information for enabling the rules engine to obtain the desired information from the rules database. More specifically, a fare linear includes fare basis codes and market information (e.g., airport or city codes) for each fare of the fare linear's itinerary, as will be discussed below. As an example, following is a fare linear of an itinerary from DTT to OKC and back on Northwest Airlines:
DTT NW OKC230.70MROP NW DTT230.70MROP 461.40 END ZPDTWOKC XFDTW4.50KC3 EG NOT APPLICABLE—ADT FARE USED—VERIFY RESTRICTIONS

As an alternative to using the fare linear, it may be possible for other information that identifies the itinerary to be submitted at block 110, such as the passenger name record, fare basis, carrier, date, origin information, departure information, and fare amount. Of course the information submitted at block 110 includes other attributes, such for letting the rules engine know the booking engine to which the rules engine is to respond.

At block 115, the booking engine receives from the rules engine, via the consultation communication path 42, a rules record 44 that includes sufficient information about the terms of the prior purchase (e.g., restrictions and penalties specified in the agreement under which the prior purchase was consummated) so that the website/booking engine can determine from the information in the record whether to facilitate or block subsequent transaction(s) for the prior purchases. A representative rules record 44 is schematically illustrated as traveling along the consultation communication path 42 from the consultant's server 20 to one of the vendor's servers 22 in FIG. 1. In accordance with one embodiment of the present invention, the information included in the rules record 44 is derived from Category 16 rules that are contained in the rules database on the consultant's server 20 and originated from the Airline Tariff Publishing Company (ATPCO), as will be discussed in greater detail below. Those of ordinary skill in the art will understand that Category 16 rules are conventional and specify the terms (e.g., restrictions and penalties) for agreements under which travel itineraries are purchased.

At one level of abstraction for the present invention, the information that is contained by the rules record 44 and thereby received by the booking engine at block 115 can be in many different forms, so long as the received information is sufficiently informative to allow for the operations of the present invention that utilize the information. Also and depending on the amount of information that is received by the booking engine at block 115, the information may be segregated into separate packages that are separately transmitted from the consultant's server 20 to the vendor's server 22 along the consultation communication path 42. Often throughout this Detailed Description section of this disclosure, the rules record 44 will be referred to in a generic sense, because it would be typical for a different rules record 44, namely a rules record 44 with different content, to be associated with each of multiple different prior purchases for which a subsequent transaction is desired.

At block 120, a determination is made by the booking engine based on information from the rules record 44 as to whether subsequent transaction(s) can be made for the prior purchase. That is, the data in the rules record 44 is read and analyzed under the control of a software module of the booking engine, for the purpose of making this decision. For example, it may not be possible to make subsequent transactions for the prior purchases if the booking engine determines from the rules record 44 that terms of the prior purchase specify that no subsequent transaction could ever be made for it, or that the timeframe for making subsequent transaction(s) for the prior purchases had expired. If the booking engine determines that no subsequent transactions for the prior purchases can be made, then control is transferred to block 125. At block 125 the booking engine and/or the website function so that the user is not presented with options for making any subsequent transactions for the prior purchase. Alternatively or in addition, the user may be explicitly notified, via the website and the Internet communication path 25, that any subsequent transactions for the prior purchase can only be made by contacting the respective provider directly.

If it is determined at block 120 that subsequent transaction(s) for the prior purchase can be made, then control is transferred to block 130. At block 130, the booking engine and website function together to display to the user, via the website and the Internet communication path 25, the transaction(s) that can be made for the prior purchase. For example, it may be indicated to the user that the entire prior purchase, or portions thereof, can be cancelled. Generally described, one type of cancellation can be more specifically described as a void. For a void, a relatively small amount of time has passed (in one example, about twenty four hours or less) since the purchase was made, so that the user/purchaser has not yet been billed for the purchase and the purchase can be voided without the user ever being billed for the purchase, such that the act of refunding need not be considered. Whether or not a void can be completed will be determined based upon the date of the prior purchase (e.g., the date the subject ticket was brought), as determined from the rules record 44. This void feature may be particularly advantageous for a purchaser who has purchased a nonrefundable ticket, because by voiding such a ticket the user is not charged for it. As another example, it may be indicated to the user at block 130 that the prior purchase, or portions thereof, can be modified, such as by being exchanged. At block 130, both canceling and exchanging options may be made available for a prior purchase, or in some cases only one of these options may be available, depending upon the terms indicated in the rules record 44.

More specifically regarding the option of exchange that may, if appropriate, be made available to the user at block 130, this option preferably includes the website/booking engine assisting the user in figuring out how to do the exchanging, such as by facilitating/allowing the user to conduct searches through goods and/or services that are being offered for sale and can be part of the exchange. For example, it may be possible to individually modify different segments of the prior purchase, such as when the prior purchase is a travel itinerary. More specifically, it may be possible to exchange one segment of a ticketed itinerary (e.g., a ticket for a seat on a flight) for another segment (e.g., a ticket for a seat on a different flight). For example, while a user is pursuing an exchange on the vendor's website and requests that a search be performed for airline tickets that are available between an origin and an destination for a particular date, or the like, the booking engine facilitates the search and has the search results displayed to the user via the vendor's website. More specifically, the booking engine preferably facilitates the search by communicating with the distributor's server 30, via the distributing communication path 34, and causing a search to be performed through database(s) on the distributor's server 30 that contain information about airline tickets that are relevant to the search. The search results are returned from the distributor's server 30 to the vendor's server 22 via the distributing communication path 34, and thereafter the search results are displayed to the user via the website and the Internet communication path 25.

At block 135, the website/booking engine determines whether the user selected, via the Internet communication path 25, to proceed with a subsequent transaction which was presented to the user at block 130. Stated differently, control can generally remain at block 130 unless the user selected, via the Internet communication path 25, to proceed with a subsequent transaction which was presented to the user at block 130. If the user selects, via the Internet communication path 25, to proceed with a subsequent transaction which is presented to the user at block 130, then control is transferred to block 140.

At block 140, the booking engine responds to the selection of the subsequent transaction which was received at block 135. More specifically, at block 140, the booking engine calculates, and the website displays to the user, via the Internet communication path 25, the overall financial considerations associated with the selected subsequent transaction. These operations by the booking engine/website at block 140 include determining from the rules record 44, which was received at the most recent occurrence of block 115, any penalties associated with the selected subsequent transactions, incorporating the penalties, if any, into the calculating, displaying to the user the penalties, if any, and displaying to the user the monetary refund or monetary amount due if the selected subsequent transaction is consummated. Also at block 140, the website presents to the user, via the Internet communication path 25, an option of confirming that they wish to consummate the selected subsequent transaction. In an effort to avoid inadvertent confirmations, a double confirmation may be required. For example, on the graphical user interface associated with the website and displayed to the user at block 140, the user may have to both select a box (e.g., put an “x” in a box) and click on a “confirmation” button.

If the website receives, at block 145 and via the Internet communication path 25, an indication from the user that the user does not want to consummate the selected subsequent transaction (i.e., if confirmation is not received), then control is transferred back to block 130, which is described above. On the other hand, if the website receives an indication from the user, at block 145 and via the Internet communication path 25, that the user does want to consummate the selected subsequent transaction, then control is transferred to block 155.

At block 155, the booking engine requests a confirmation from the distributor, or more specifically from its server 30 via the distributing communication path 34, as to whether or not to proceed with the selected subsequent transaction. More specifically, at block 155 the booking engine sends a request for confirmation over the distributing communication path 34 to the distributor's server 30. It is advantageous for the booking engine to request this confirmation because information about the goods or services that are the subject of the selected subsequent transactions may need to be updated or verified before completing the selected subsequent transaction. Such confirmation would be desired, for example, if the selected subsequent transaction includes exchanging a ticket on a first airline flight for a ticket on a second airline flight, because it would be beneficial to obtain confirmation from the distributor that the ticket on the second airline flight is still available. As another example, it can be advantageous to obtain a confirmation when canceling a prior purchase of a ticket for a seat on an airline flight, to ensure that the ticket has not already been cancelled.

At block 160, the booking engine receives a response over the distributing communication path 34. At block 165, the booking engine analyzes the response received from the distributor's server 30 at block 160 and determines whether the selected subsequent transaction can be made. If the selected subsequent transaction cannot be made (e.g., because the proposed subsequent transaction includes an exchange for something that is no longer available), the user is notified via the respective Internet communication path 25. This notification can be facilitated by the website providing to the user a webpage with a suitable written notice and/or reverting to an earlier webpage, as is schematically illustrated in FIG. 2 by control being transferred from block 165 to block 130 in response to a negative determination at block 165.

If the booking engine determines at block 165 that the selected subsequent transaction can be made, then control is transferred to block 170. At block 170, the booking engine and the website function together to initiate performance of/completion of the selected subsequent transaction. For example, the website can display a confirming webpage to the user, via the Internet communication path 25, indicating that the selected subsequent transaction has been consummated. Alternatively or in addition, the booking engine may cause an email or other confirming message to be sent to the user. These confirmations can be customized for handling a variety of different situations. For example, it the prior purchase being modified or cancelled is a hotel reservation, the confirmation may put the user of the system on notice that the hotel may impose a penalty that has not been taken into consideration by the booking engine. In addition, the booking engine will notify the distributor of the consummation via the distributing communication path 34 and the distributor's server 30.

Operations at block 170 can also include, as appropriate, receiving payments from the user and distributing the payment accordingly so that at least some of it eventually reaches the respective provider. Operations at block 170 can additionally include, as appropriate, making a refund payment to the user and/or instructing the appropriate providers to make a refund payment to the user. The distribution of the payments at block 170 can be facilitated via an intermediary, such as a creditor and/or another agency (e.g., the Airlines Reporting Corporation) which facilitates transfers of funds. Also, when the prior purchase is an airline ticket and it has been cancelled at block 170, a determination may be made at block 170 as to whether the cancelled ticket has a reissue value. In addition, when the subsequent transaction is for a travel itinerary, it is preferred for the booking engine to communicate with the distributor's server 30 via the distributing communication path 34 and cause the passenger name record associated with the travel itinerary to fully reflect the subsequent transaction. Also, a review of the passenger name record by a third party (e.g., a travel agency) can be initiated, to verify that the subsequent transaction reflected in the passenger name record was accurately handled by the booking engine. This may be done by placing the subject passenger name record in a queue for review at the distributor's server 30.

In accordance with an alternative embodiment of the present invention, the operations at block 170 merely show the user the repercussions of completing any possible subsequent transactions, without further initiating the consummation of the subsequent transactions. This alternative approach may be used, for example, if it is determined that the users would like to be fully informed by the commerce system 18 about the possible subsequent transactions, but would rather consummate them only after speaking with a travel agent, or otherwise further considering the repercussions prior to completing the subsequent transactions.

The software modules of the present invention can preferably be readily manipulated so that numerous of the above-described features of the booking engine and website can be individually and/or collectively enabled and disabled.

Operations of the Consultant's Rules Engine

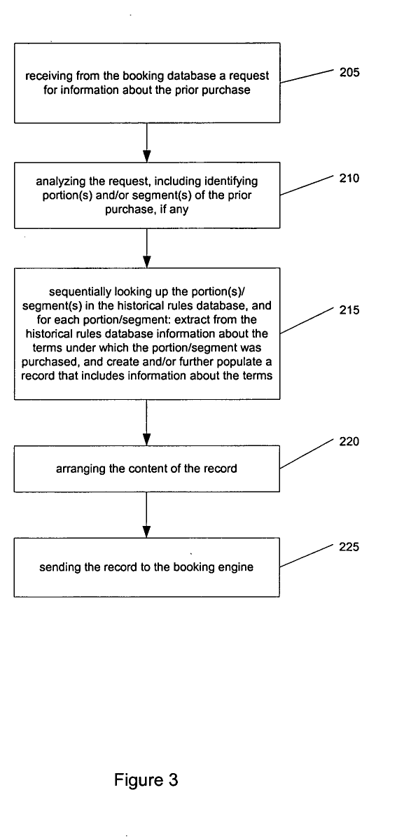

FIG. 3 illustrates operations of the rules engine, which preferably resides on or is in communication with the consultant's server 20 but could alternatively be on one of the vendor's servers 22, or on any of the other servers 26, 28, 30, along with the rules database and rules loader, in accordance with one embodiment of the present invention. At block 205, the rules engine receives a request for information about a prior purchase from one of the booking engines, via the consultation communication path 42. For example, the request received by the rules engine at block 205 can originate from block 110 of FIG. 2; therefore, the request can be as described above with reference to block 110. Referring back to FIG. 3 and in accordance with one embodiment of the present invention, the prior purchase is a travel itinerary and the information received at block 205 includes the “fare linear” from the electronic ticket record that is part of the passenger name record assigned to the itinerary.

Very generally described, at block 210, the rules engine reads, or causes to be read, the request for information received at block 205. As part of the reading, it is preferred for the rules engine to identify the portion(s) and/or segment(s) of the prior purchase. More specifically, if the prior purchase is a travel itinerary, the fare linear from the electronic ticket record that is part of the passenger name record that is assigned to the itinerary is received at block 205, and at block 210 the rules engine extracts the fare basis code(s) and market information (e.g., airport or city codes) for each of the one or more fares identified by the fare linear received at block 205.

At block 215, the rules engine preferably sequentially looks up information about each of the portion(s)/segment(s) identified at block 210. This looking up is done in the historical rules database. For each portion/segment, the rules engine extracts from the historical rules database information about the terms (e.g., restrictions and penalties) under which the portion/segment was purchased, and creates and/or further populates the rules record 44 with the information about the terms. If the prior purchase includes only one portion or segment, then the rules record 44 would primarily only include terms about that one portion or record.

Regarding block 215 more specifically and in accordance with one embodiment of the present invention, the prior purchase is an itinerary that can include one or more fares, and for each fare, the fare basis codes and market information were obtained from the associated fare linear at block 210. At block 215, the looking up that is done for each fare preferably includes a first step followed by a second step. The first step includes the rules engine using the fare basis code and market information to look up in the rules database the rule and tariff number that applies to the fare. The rule and tariff number is conventionally included in data published by the Airline Tariff Publishing Company (ATPCO), and preferably the data uploaded from the publisher's server 28 to the consultant's server 20 via the publishing communication path 40 includes conventional data published by ATPCO. As the second step for each fare, the rule and tariff number obtained at the first step for the fare is used to obtain the terms (e.g., restrictions and penalties) for the fare from the rules database. Preferably these terms that are located as part of the second step are from conventional Category 16 fields (e.g., Record 3 data) within the ATPCO-originated data that is within the rules database. This information from the Category 16 fields is reflected in the rules record 44 and can be used by the booking engine to make decisions about cancellations and exchanges, and any associated refunds and amounts due, as discussed above with reference to FIG. 2.

The computer-readable data retrieved from, or viewed in, the rules database at block 215 is preferably converted, or replicated, by the rules engine, or under the control of the rules engine, as part of the process of placing it in the rules record 44 at block 215. During this conversion or replication, the computer-readable data is preferably converted to, or replicated in, a relatively higher-level computer language as compared to the computer-readable data retrieved from, or viewed in, the rules database. This higher-level computer language preferably defines characteristics for data, and it is preferably a markup language, and most preferably it is extensible markup language (XML). XML is a conventional markup language that will be understood by those of ordinary skill in the art. Accordingly, the terms of the prior purchase (e.g., restrictions and penalties specified in the agreement under which the prior purchase was consummated) that are contained by the rules record 44 are recorded in a markup language format, which is preferably XML.

The looking up performed by the rules engine at block 215 is preferably performed by data accessing algorithms encoded within the rules engine. In addition and for further facilitating the looking up of information at block 215, the rules engine can further include a natural language processing (NLP) component for understanding and facilitating the enforcement of exclusions coded as free-form text within the data filed by the airline providers and included in the ATPCO-originated data within the rules database. The NLP component of the rules engine can preferably analyze the free-form text/language within the rules database based on a travel-industry vocabulary and can be customized to determine answers to key questions that pertain to cancellation/exchange/refund rules. The NLP component of the rules engine seeks to ensure that all rule parameters specified by airline providers and included in the ATPCO data within the rules database are duly considered when making void/exchange/refund decisions.

In accordance with one example, the prior purchase for which a request for information is received at block 205 includes multiple segrnents/portions. In accordance with this example, the rules engine is preferably operative at block 215 so that the rules record 44 initially includes at least one subrecord for each of the segments/portions, and so that at block 220 the subrecords are arranged in a predetermined manner. In accordance with one embodiment of the present invention, the prior purchase is preferably an itinerary; therefore, for each subrecord there can be both cancellation/refund and exchange information. At block 220, it is preferred for the cancellation/refund information to be segregated from the exchange information.

Accordingly, if the prior purchase is an itinerary that includes multiple portions or segments, then after the segregating performed by the rules engine at block 220, the rules record 44 for the itinerary will include a first group of information that is about cancellations/refunds, and a second group of information that is about exchanges. For each of those groups, it is preferred for the rules engine to arrange the information within the group by most restrictive, so that for each group the most restrictive entry is positioned before the less restrictive entries, and the entries are arranged in a progressively less restrictive order. That is, and depending upon the frame of reference, the information within the groups is arranged serially in ascending or descending order.

At block 225, the rules engine initiates the sending of the rules record 44 to the booking engine via the consultation communication path 42. For example, the rules record sent by the rules engine at block 225 can be received by the booking engine at block 115 of FIG. 2.

Computer Program Products

Each of the computers 24 and servers 20, 22, 26, 28, 30 preferably includes conventional processor(s), memory/data storage device(s), interface(s) such as for interfacing with users and for facilitating the communications schematically illustrated by the communication paths 25, 29, 32, 34, 40, 42. More specifically and for example, each of the processors is typically comprised of a combination of hardware, such as one or more microprocessors or other processing devices typically embodied by a personal computer, a server computer or other computing device, and software that is stored by memory and executed by the hardware to implement methodologies, respectively such as the methodologies described herein. However, the processors can be comprised of other combinations of hardware, software, firmware or the like so long as the resulting combination is capable of respectively implementing the methodologies described herein. The interfaces can be any interfaces known to those skilled in the art. For example, the interfaces for receiving input can include a keyboard, a mouse, a trackball, a touch screen, or the like. The interfaces for providing output can include a display for presenting information, such as a display that provides a graphical user interface. The interfaces for communicating with the Internet or other networks (e.g., respectively over the communication paths 25, 29, 32, 34, 40, 42) can be any of the interfaces known by those of ordinary skill for this purpose, such as a modem, network interface card, router, multiplexer, or the like.

The processors of the computers 24 and servers 20, 22, 24, 26, 28 respectively generally operate under control of computer program products. Each of these computer program products are for respectively performing the methods of embodiments of the present invention and include a computer-readable storage medium, such as a non-volatile storage medium, and computer-readable program code portions, such as a series of computer instructions, embodied in the computer-readable storage medium.

These computer program instructions may be loaded onto a computer or other programmable apparatus to produce a machine, such that the instructions, which execute on the computer or other programmable apparatus create devices or means for implementing the above-described functions. These computer program instructions may also be stored in a computer-readable memory, such as a memory device, that can direct a computer or other programmable apparatus to function in a particular manner, such that the instructions stored in the computer-readable memory produce an article of manufacture including instruction devices or means which implement the functions of the present invention. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified above.

Heretofore, no particular programming language has been described for carrying out some of the various methods that are apparent from the foregoing, because it is considered that the operations described above and illustrated in the accompanying drawings are sufficiently disclosed to permit one of ordinary skill in the art to practice the present invention. Moreover, there are many computers and operating systems which may be used in practicing the present invention. Each user of a particular computer will be aware of the language and tools which are most useful for that user's needs and purposes. Nonetheless, for purposes of providing examples and not for the purpose of narrowing the scope of the present invention, the rules engine and rules loader can be written in Java brand programming language, namely in accordance with a Java Database Connectivity (JDBC) brand application program interface; the rules database can be a relational database that maps the data from ATPCO to a database schema optimized for storing ATPCO fares and rules data for fast lookup, and the rules database can be managed using Oracle brand products and/or the MySQL relational database management system. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for processing information regarding subsequent transactions for purchases of items from at least one provider, wherein the method is performed by at least one processor and comprises:
receiving data which is provided by the provider or a surrogate of the provider and regards subsequent transactions for purchases of items from the provider;
arranging the data into at least one database;
creating a record, including:
retrieving, from the database, data that is indicative of whether at least one subsequent transaction can be carried out for at least one item purchased from the provider, and if so, a manner in which the subsequent transaction can be carried out, and
populating the record with at least some of the retrieved data, wherein the populating of the record with the retrieved data includes converting at least some of the retrieved data into a higher-level computer language so that at least some of the data that is in the record and was retrieved from the database has been converted to, and is expressed in, the higher-level computer language, with the higher-level computer language being higher-level as compared to the data retrieved from the database; and
making the record available to software modules for use in determining whether at least one subsequent transaction can be carried out for at least one item purchased from the provider, and if so, a manner in which the subsequent transaction can be carried out.

2. The method according to claim 1, wherein the item purchased is a travel itinerary so that there is a fare linear associated with the travel itinerary, and wherein:
the receiving of the data which is provided by the provider or a surrogate of the provider includes receiving the data from a global distribution system;
the making of the record available to the software modules includes making the record available to at least a booking engine and a website that are:
cooperative for facilitating the purchase of the travel itinerary, and
cooperative with the record for facilitating the subsequent transaction for the travel itinerary;
the retrieving of the retrieved data from the database includes using the fare linear in the retrieving of the retrieved data from the database, and
the converting of at least some of the retrieved data to a higher-level computer language includes converting at least some of the retrieved data to a markup language.

3. The method according to claim 1, wherein the receiving of the data which is provided by the provider or a surrogate of the provider includes receiving the data from a global distribution system.

4. The method according to claim 1, wherein the making of the record available to the software modules includes sending the record to the software modules.

5. The method according to claim 1, wherein the making of the record available to the software modules includes making the record available to at least a booking engine and a website that are:
cooperative for facilitating the purchase of the item purchased, and
cooperative with the record for facilitating the subsequent transaction for the item purchased.

6. The method according to claim 1, wherein:
the item purchased is a travel itinerary so that there is a fare linear associated with the travel itinerary, and
the retrieving of the retrieved data from the database includes using the fare linear in the retrieving of the retrieved data from the database.

7. The method according to claim 6, wherein the using of the fare linear in the retrieving of the retrieved data from the database includes:
obtaining a fare basis code and market information from the fare linear,
using the fare basis code and market information to look up and obtain a rules and tariff number from the database, and
using the rules and tariff number to look up and obtain information about restrictions and penalties from the database.

8. The method according to claim 1, wherein the retrieving of the retrieved data from the database includes retrieving serialized alphanumeric data from the database.

9. The method according to claim 8, wherein the retrieving of the retrieved data from the database consists essentially of retrieving serialized alphanumeric data from the database.

10. The method according to claim 1, wherein the converting of at least some of the retrieved data into the higher-level computer language includes converting at least some of the retrieved data to a markup language.

11. The method according to claim 10, wherein:
the retrieving of the retrieved data from the database includes retrieving serialized alphanumeric data from the database, and
the converting of at least some of the retrieved data to the markup language includes converting at least some of the serialized alphanumeric data to extensible markup language.

12. The method according to claim 1, wherein the populating of the record with the retrieved data includes arranging the retrieved data in a predetermined manner in the database.

13. The method according to claim 12, wherein the arranging of the retrieved data in the predetermined manner includes arranging the retrieved data serially in ascending or descending order.

14. The method according to claim 1, further comprising receiving from the software modules a request for the record, wherein the creating of the record is responsive to the receiving of the request for the record.

15. The method according to claim 14, further comprising receiving the sent record and using it in conjunction with the software modules to facilitate, over the Internet, an exchange or cancellation for at least a portion of the item purchased.

16. The method according to claim 14, further comprising previously using the software modules to facilitate, over the Internet, the purchase of the item purchased.

17. The method according to claim 1, further comprising receiving a request for an exchange or cancellation for at least a portion of the item purchased.

18. The method according to claim 1, further comprising querying the record to determine whether at least one subsequent transaction can be carried out for the item purchased, and if so, a manner in which the subsequent transaction can be carried out for the item purchased.

19. The method according to claim 18, wherein the querying of the record to determine the manner in which the subsequent transaction can be carried out for the item purchased includes calculating, at least partially based upon information in the record, any monetary refund or monetary amount that will be due if the subsequent transaction is completed.

20. A computer-readable medium having computer executable instructions for performing the operations recited in claim 1.

21. A method for processing information regarding subsequent transactions for purchases of items from at least one provider, wherein the method is performed by at least one processor and comprises:
receiving data which is provided by the provider or a surrogate of the provider and regards subsequent transactions for purchases of items from the provider;
arranging the data into at least one database;
creating a record, including:
retrieving, from the database, data that is indicative of whether at least one subsequent transaction can be carried out for at least one item purchased from the provider, and if so, a manner in which the subsequent transaction can be carried out, and
populating the record with at least some of the retrieved data; and
making the record available to software modules for use in determining whether at least one subsequent transaction can be carried out for at least one item purchased from the provider, and if so, a manner in which the subsequent transaction can be carried out.

22. The method according to claim 21, wherein the item purchased is a travel itinerary so that there is a fare linear associated with the travel itinerary, and wherein:
the receiving of the data which is provided by the provider or a surrogate of the provider includes receiving the data from a global distribution system;
the making of the record available to the software modules includes making the record available to at least a booking engine and a website that are:
cooperative for facilitating the purchase of the travel itinerary, and
cooperative with the record for facilitating the subsequent transaction for the travel itinerary; and
the retrieving of the retrieved data from the database includes using the fare linear in the retrieving of the retrieved data from the database.

23. The method according to claim 21, wherein the receiving of the data which is provided by the provider or a surrogate of the provider includes receiving the data from a global distribution system.

24. The method according to claim 21, wherein the making of the record available to the software modules includes making the record available to at least a booking engine and a website that are:
cooperative for facilitating the purchase of the item purchased, and
cooperative with the record for facilitating the subsequent transaction for the item purchased.

25. The method according to claim 21, wherein:
the item purchased is a travel itinerary so that there is a fare linear associated with the travel itinerary, and
the retrieving of the retrieved data from the database includes using the fare linear in the retrieving of the retrieved data from the database.

26. The method according to claim 25, wherein the using of the fare linear in the retrieving of the retrieved data from the database includes:
obtaining a fare basis code and market information from the fare linear,
using the fare basis code and market information to look up and obtain a rules and tariff number from the database, and
using the rules and tariff number to look up and obtain information about restrictions and penalties from the database.

27. The method according to claim 21, wherein the populating of the record with the retrieved data includes arranging the retrieved data in a predetermined manner in the database.

28. The method according to claim 27, wherein the arranging of the retrieved data in the predetermined manner includes arranging the retrieved data serially in ascending or descending order.

29. The method according to claim 21, further comprising receiving from the software modules a request for the record, wherein the creating of the record is responsive to the receiving of the request for the record.

30. The method according to claim 29, further comprising receiving the sent record and using it in conjunction with the software modules to facilitate, over the Internet, an exchange or cancellation for at least a portion of the item purchased.

31. The method according to claim 29, further comprising previously using the software modules to facilitate, over the Internet, the purchase of the item purchased.

32. The method according to claim 21, further comprising receiving a request for an exchange or cancellation for at least a portion of the item purchased.

33. The method according to claim 21, further comprising querying the record to determine whether at least one subsequent transaction can be carried out for the item purchased, and if so, a manner in which the subsequent transaction can be carried out for the item purchased.

34. The method according to claim 33, wherein the querying of the record to determine the manner in which the subsequent transaction can be carried out for the item purchased includes calculating, at least partially based upon information in the record, any monetary refund or monetary amount that will be due if the subsequent transaction is completed.

35. A computer-readable medium having computer executable instructions for performing the operations recited in claim 21.

36. A method for handling a request by a user for at least one subsequent transaction for at least one item that was previously purchased from a provider, wherein the method is performed by at least one processor and comprises:
receiving data which is provided by the provider or a surrogate of the provider and regards subsequent transactions for purchases of items from the provider;
arranging the data into at least one database;
operating a website so that the website receives a request from the user, with the request from the user relating to the previously purchased item;
operating a first engine, which is associated with the website, to send to a second engine a request for information about the previously purchased item;
operating the second engine to:
create at least one record in response to the request for information about the previously purchased item, including:
retrieving, from the database, data that is indicative of whether at least one subsequent transaction can be carried out for the previously purchased item, and if so, a manner in which the subsequent transaction can be carried out, and
populating the record with the retrieved data, and making the record available to the first engine;
operating the first engine to analyze the record to determine whether at least one subsequent transaction can be carried out for the previously purchased item;
operating the website to inform the user that the subsequent transaction can be carried out for the previously purchased item;
receiving at the website a request from the user to complete the subsequent transaction; and
operating the website and the first engine to at least initiate completion of the subsequent transaction, including operating the first engine to at least partially determine from the record a manner in which the subsequent transaction can be carried out.

37. The method according to claim 36, wherein:
the previously purchased item is a travel itinerary so that a fare linear is associated with the travel itinerary, and
the retrieving from the database includes using the fare linear in the retrieving from the database.

38. The method according to claim 36, wherein the populating of the record with the retrieved data includes segregating data relating to exchanges and cancellations and arranging the segregated data in ascending or descending order.

39. The method according to claim 36, wherein the populating of the record with the retrieved data includes converting at least some of the retrieved data into a higher-level computer language so that at least some of the data that is in the record and was retrieved from the database has been converted to, and is expressed in, the higher-level computer language, with the higher-level computer language being higher-level as compared to the data retrieved from the database.

40. The method according to claim 39, wherein the converting of at least some of the retrieved data into the higher-level computer language includes converting at least some of the retrieved data to a markup language.

41. A system for handling a request by a user for at least one subsequent transaction for at least one item that was previously purchased from a provider, the system comprising:
one or more software modules for:
receiving data which is provided by the provider or a surrogate of the provider and regards subsequent transactions can be carried out for purchases of items from the provider, and
arranging the data into at least one database;
a website for receiving a request from the user, with the request from the user relating to the previously purchased item;
a first engine for at least partially operating in conjunction with the website; and
a second engine, wherein:
the first engine is for sending to the second engine a request for information about the previously purchased item,
the second engine is for:
creating at least one record in response to the request for information about the previously purchased item, including:
retrieving, from the database, data that is indicative of whether at least one subsequent transaction can be carried out for the previously purchased item, and if so, a manner in which the subsequent transaction can be carried out, and
populating the record with the retrieved data, and
making the record available to the first engine;
wherein the first engine is further for analyzing the record to determine whether a subsequent transaction can be carried out for the previously purchased item;
wherein the website is further for:
informing the user that the subsequent transaction can be carried out for the previously purchased item,
receiving a request from the user to complete the subsequent transaction, and
operating in conjunction with the first engine to at least initiate completion of the subsequent transaction, and
wherein the first engine is further for at least partially determining from the record how the subsequent transaction can be carried out.

42. The system according to claim 41, wherein the first and second engines are on different computer servers.

43. The system according to claim 41, further comprising:
a global distribution system that is for uploading data, which is at least used in the initiation of the completion of the subsequent transaction, to the first engine; and
an Airline Tariff Publishing Company which is the surrogate of the provider and is for uploading to the global distribution system the data which is at least used in the initiation of the completion of the subsequent transaction.

44. The system according to claim 41, wherein the populating of the record with the retrieved data includes converting at least some of the retrieved data into a higher-level computer language so that at least some of the data that is in the record and was retrieved from the database has been converted to, and is expressed in, the higher-level computer language, with the higher-level computer language being higher-level as compared to the data retrieved from the database.

45. The system according to claim 44, wherein the converting of at least some of the retrieved data into the higher-level computer language includes converting to a markup language.
